(19) United States
(12) Patent Application Publication
(10) Pub. No.: US 2007/0154208 A1
(43) Pub. Date: Jul. 5, 2007

(54) Light-filtering module for an image-capturing device

(76) Inventor: Ming-Tsun Chen, Kaohsiung City (TW)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/320,889

(22) Filed: Dec. 30, 2005

(51) Int. Cl. G03B 9/02

(52) U.S. Cl. 396/508

(57) ABSTRACT

A light-filtering module for an image-capturing device includes a casing, a sliding filter unit, and an actuator unit. The casing is formed with an aperture in spatial communication with a slide groove. The sliding filter unit includes a lens set slidable in the slide groove between a first position, where a first lens component is aligned with the aperture, and a second position, where a second lens component is aligned with the aperture. The actuator unit includes an electromagnetic coil set and an armature unit having a magnetic rod portion connected to the sliding filter unit and extending movably into an armature hole in the electromagnetic coil set. By energizing the electromagnetic coil set, the armature unit can be driven for moving the lens set to a selected one of the first and second positions.

### BACKGROUND OF THE INVENTION

1. Field of the Invention

The invention relates to a light-filtering module, more particularly to a light-filtering module for an image-capturing device.

2. Description of the Related Art

Images captured by an image-capturing device, such as a surveillance camera, are likely to be poor in cases of extreme ambient light conditions, i.e., too much or too little ambient light. While auxiliary lighting or night vision techniques could be employed to improve image quality in the case of inadequate ambient light, the issue of improving image quality when capturing images under strong ambient light conditions is still required to be resolved.

Referring to FIGS. 1 and 2, in Taiwanese Patent Publication No. 566791, there is disclosed a conventional light-filtering module for a surveillance camera. The light-filtering module includes a motor 5 that is controlled by a light-sensing circuit (not shown). In case of poor ambient light conditions, the motor 5 is activated to move a lens holder 8 such that a transparent lens component 10 on the lens holder 8 is aligned with a lens unit of the surveillance camera (not shown) to optimize the amount of light that enters the lens unit. On the other hand, in case of strong ambient light conditions, the lens holder 8 is moved through a restoring spring mechanism 7 such that a filtering lens component 9 on the lens holder 8 is aligned with the lens unit of the surveillance camera so as to filter out strong light rays and improve the quality of images captured by the surveillance camera.

However, since the restoring spring mechanism 7 is an unreliable component that is susceptible to spring fatigue, correct positioning of any of the lens components 9, 10 relative to the lens unit of the surveillance camera cannot be ensured. Moreover, the motor 5 is a bulky component that necessitates a corresponding increase in the size and cost of the surveillance camera in order to accommodate the motor 5 therein.

### SUMMARY OF THE INVENTION

Therefore, the object of the present invention is to provide a light-filtering module for an image-capturing device that can overcome at least one of the aforesaid drawbacks associated with the prior art.

According to the present invention, a light-filtering module comprises a casing, a sliding filter unit, and an actuator unit.

The casing defines a slide groove, and is formed with an aperture in spatial communication with the slide groove.

The sliding filter unit includes a lens set disposed in the slide groove, and an actuator coupling member coupled to the lens set and extending outwardly of the slide groove. The lens set includes first and second lens components, one of which is a light-filtering lens. The lens set is slidable in the slide groove between a first position, where the first lens component is aligned with the aperture, and a second position, where the second lens component is aligned with the aperture.

The actuator unit includes an electromagnetic coil set and an armature unit. The electromagnetic coil set is mounted on the casing externally of the slide groove, and defines an armature hole therethrough. The armature unit has a magnetic rod portion connected to the actuator coupling member and extending movably into the armature hole, and a supporting rod portion connected to and extending co-axially from the magnetic rod portion. By energizing the electromagnetic coil set, the armature unit can be driven for moving the lens set to a selected one of the first and second positions in the slide groove.

### BRIEF DESCRIPTION OF THE DRAWINGS

Other features and advantages of the present invention will become apparent in the following detailed description of the preferred embodiment with reference to the accompanying drawings, of which:

FIGS. 1 and 2 are perspective views of a conventional light-filtering module for a surveillance camera;

FIG. 3 is an exploded perspective view of the preferred embodiment of a light-filtering module for an image-capturing device according to the present invention; and

FIGS. 4 and 5 are assembled perspective views of the preferred embodiment.

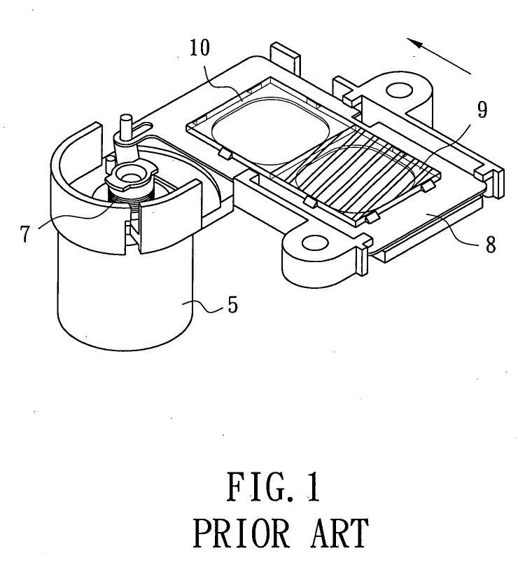

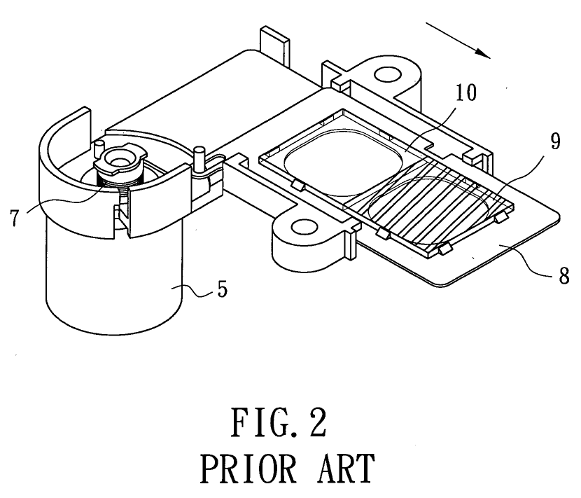

### DETAILED DESCRIPTION OF THE PREFERRED EMBODIMENT

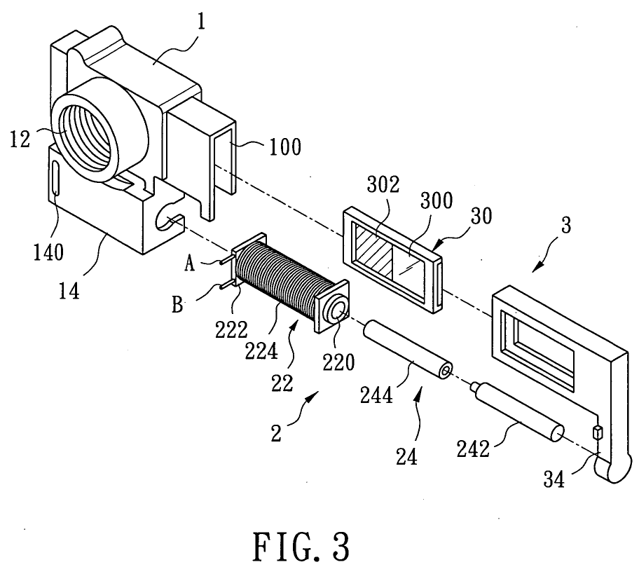

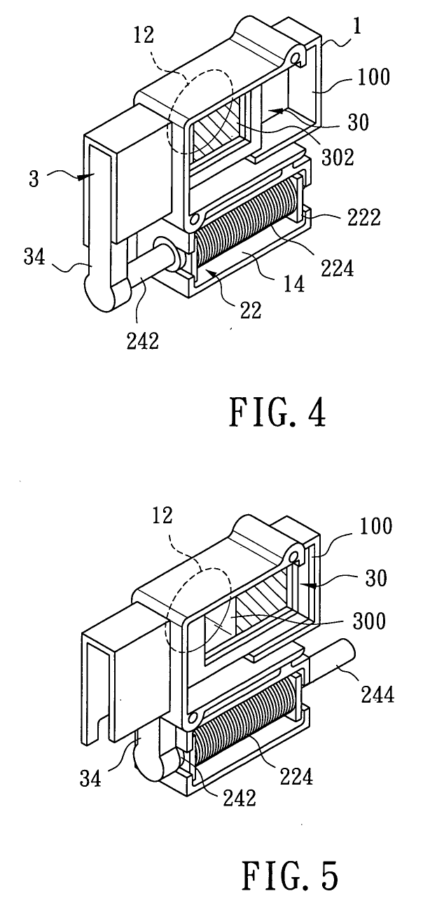

Referring to FIGS. 3 and 4, the preferred embodiment of a light-filtering module according to the present invention is shown to be adapted for application to an image-capturing device, such as a surveillance camera, and includes a casing 1, a sliding filter unit 3, and an actuator unit 2.

The casing 1 defines a slide groove 100, and is formed with an aperture 12 that is in spatial communication with the slide groove 100. The aperture 12 is to be aligned with a lens unit of the image-capturing device (not shown).

The sliding filter unit 3 includes a lens set 30 disposed in the slide groove 100, and an actuator coupling member 34 coupled to the lens set 30 and extending outwardly of the slide groove 100. The lens set 30 includes first and second lens components 302, 300. In this embodiment, the first lens component 302 is a light-filtering lens, whereas the second lens component 300 is an ordinary transparent lens. The lens set 30 is slidable in the slide groove 100 between a first position, where the first lens component 302 is aligned with the aperture 12, as best shown in FIG. 4, and a second position, where the second lens component 300 is aligned with the aperture 12, as best shown in FIG. 5.

The actuator unit 2 includes an electromagnetic coil set 22 and an armature unit 24. The electromagnetic coil set 22 is mounted on the casing 1 externally of the slide groove 100, and defines an armature hole 220 therethrough. The armature unit 24 has a magnetic rod portion 242 connected to the actuator coupling member 34 and extending movably into the armature hole 220, and a supporting rod portion 244 connected to and extending co-axially from the magnetic rod portion 242. Preferably, the magnetic rod portion 242 is a permanent magnet, and the supporting rod portion 244 is made from a non-magnetically attractive material.

In this embodiment, the casing 1 has one side provided with a coil-mounting seat 14 that is disposed outwardly of the slide groove 100. The electromagnetic coil set 22 is retained in the coil-mounting seat 14, and includes a dielectric coil-winding frame 222 that defines the armature hole 220, and a conductive coil 224 that is wound on the coil-winding frame 222. The coil-mounting seat 14 is formed with a slot 140 (see FIG. 3) to enable extension of end segments (A, B) of the coil 224 therethrough. The end segments (A, B) of the coil 224 are adapted to be connected electrically to a light-responsive driver circuit (not shown) of the image-capturing device. Since the feature of this invention does not reside in the structure of the light-responsive driver circuit as well as the functions associated therewith, further details thereof are omitted herein for the sake of brevity.

The electromagnetic coil set 22 is capable of being energized by the aforementioned light-responsive driver circuit so as to drive movement of the armature unit 24 for moving the lens set 30 to a selected one of the first and second positions in the slide groove 100. In particular, with reference to FIG. 5, upon detection by the light-responsive driver circuit that the ambient light is insufficient for proper image-capturing, a first-polarity exciting current will be sent to the coil 224 so as to energize the coil 224 for drawing the magnetic rod portion 242 further into the armature hole 220 by virtue of magnetic attraction. As a result, the lens set 30 is moved through the actuator coupling member 34 to the second position such that the second lens component 300 is aligned with the aperture 12 in the casing 1 to optimize the amount of light that enters the lens unit of the image-capturing device.

On the other hand, as shown in FIG. 4, upon detection by the light-responsive driver circuit that the ambient light is sufficient for proper image-capturing, a second-polarity exciting current will be sent to the coil 224 so as to energize the coil 224 for extending the magnetic rod portion 242 out of the armature hole 220 by virtue of magnetic repulsion. As a result, the lens set 30 is moved through the actuator coupling member 34 to the first position such that the first lens component 302 is aligned with the aperture 12 in the casing 1 so as to filter out strong light rays and improve the quality of images captured by the image-capturing device.

When compared to the aforementioned conventional light-filtering module, movement of the lens set 30 in the slide groove 100 can be precisely controlled in view of the actuator unit 2 that includes the electromagnet coil set 22 and the armature unit 24. Moreover, since the actuator unit 2 is both small and compact, the drawbacks associated with the use of the motor in the prior art can be eliminated.

While the present invention has been described in connection with what is considered the most practical and preferred embodiment, it is understood that this invention is not limited to the disclosed embodiment but is intended to cover various arrangement included within the spirit and scope of the broadest interpretation so as to encompass all such modifications and equivalent arrangements.

What is claimed is:

1. A light-filtering module comprising:
a casing defining a slide groove and formed with an aperture in spatial communication with said slide groove;
a sliding filter unit including
a lens set disposed in said slide groove and including first and second lens components, one of said first and second lens component being a light-filtering lens, said lens set being slidable in said slide groove between a first position, where said first lens component is aligned with said aperture, and a second position, where said second lens component is aligned with said aperture, and
an actuator coupling member coupled to said lens set and extending outwardly of said slide groove; and
an actuator unit including
an electromagnetic coil set mounted on said casing externally of said slide groove, said electromagnetic coil set defining an armature hole therethrough, and
an armature unit having a magnetic rod portion connected to said actuator coupling member and extending movably into said armature hole, and a supporting rod portion connected to and extending co-axially from said magnetic rod portion,
said electromagnetic coil set being capable of being energized so as to drive movement of said armature unit for moving said lens set to a selected one of the first and second positions in said slide groove.

2. The light-filtering module as claimed in claim 1, wherein said casing has one side provided with a coil-mounting seat that is disposed outwardly of said slide groove, said electromagnetic coil set being retained in said coil-mounting seat.

3. The light-filtering module as claimed in claim 2, wherein said electromagnetic coil set includes a dielectric coil-winding frame that defines said armature hole, and a conductive coil that is wound on said coil-winding frame,
said coil-mounting seat being formed with a slot to enable extension of end segments of said coil therethrough.

4. The light-filtering module as claimed in claim 1, wherein said magnetic rod portion is a permanent magnet, and said supporting rod portion is made from a non-magnetically attractive material.

5. The light-filtering module as claimed in claim 1, wherein the other one of said first and second lens components is a transparent lens.
